(19) United States
(12) Patent Application Publication
(10) Pub. No.: US 2002/0076610 A1
(43) Pub. Date: Jun. 20, 2002

(54) High-energy density large-capacity stable battery having electrode layer containing cyclic conjugated carbonyl compound forming part of at least one electrode

(76) Inventors: Yukiko Morioka, Tokyo (JP); Masaharu Satoh, Tokyo (JP); Shigeyuki Iwasa, Tokyo (JP); Yutaka Bannai, Tokyo (JP); Kentaro Nakahara, Tokyo (JP)

Correspondence Address: McGinn & Gibb, PLLC, Suite 200, 8321 Old Courthouse Road, Vienna, VA, 22182-3817, US

(21) Appl. No.: 10/021,362

(22) Filed: Dec. 19, 2001

(30) Foreign Application Priority Data
Dec. 20, 2000 (JP) 2000-387933

(51) Int. Cl. H01M 4/60

(52) U.S. Cl. 429/213

(57) ABSTRACT

A positive electrode, negative electrode and electrolyte form in combination a battery, and at least one of the positive and negative electrodes has an electrode layer containing cyclic conjugated carbonyl compound expressed by general formula (1)

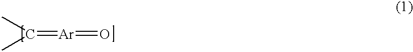

where Ar is an organic group equivalent to substituted/non-substituted aromatic compound having carbon number 5 to 14 from which two hydrogen atoms are eliminated; the battery is high in energy density, large in capacity, light and stable.

### FIELD OF THE INVENTION

This invention relates to a battery and, more particularly, to a battery containing organic compound as the active material.

### DESCRIPTION OF THE RELATED ART

A battery converts the chemical energy to the electric energy and vice versa, and accumulates the electric energy in the form of chemical energy through oxidation-reduction. The battery is used as a power source in various electric devices.

Portable electronic devices are rapidly spread, and a large-capacity and small-weight battery is required for the portable electronic devices. Thus, there is a great demand for the large-capacity and small-weight battery. Research and development efforts have been made on a battery, which uses alkaline metal ion, because the alkaline metal ion is small in mass per unit charge. Especially, the lithium ion battery is a large capacity stable battery, and is employed in the portable electronic devices. The lithium ion battery has a positive electrode formed of lithium-containing heavily metal oxide and a negative electrode formed of carbon, and converts the energy through the elimination reaction of lithium and the reverse reaction.

However, the lithium ion battery is small in capacity per unit mass. This is because of the fact that the heavily metallic compound, which is large in specific gravity, is used for the positive electrode. Thus, the lithium ion battery can not perfectly satisfy the requirement for the portable electronic devices.

A battery which does not need any heavy metal compound is required. Candidates are disclosed in U.S. Pat. No. 4,833,048 and Japanese Patent No. 2715778. The batteries have the positive electrodes formed of organic compound with disulfide linkage. The principle employed in the batteries is an electrochemical oxidation/reduction reaction where disulfide linkages are produced and dissociated. The positive electrode is formed of compound, the main components of which are light elements such as sulfur and carbon. For this reason, the batteries are fairly reduced in weight, and are near the technical goal. However, the dissociated disulfide linkages merely recombine at a low efficiency. Those batteries are less stable in charging/discharging.

Conductive polymer compounds are also available for the batteries. The principle of the battery is the doping reaction of electrolyte ion to the conductive polymer compound and the undoping reaction. The doping reaction means a phenomenon where exitons such as solitons or polarons, which are generated in the oxidation-reduction of the conductive polymer compound, are stabilized with counter ions. On the other hand, the undoping reaction is reverse to the doping reaction. The exitons stabilized with the counter ions are electrochemically oxidized or reduced in the undoping reaction. U.S. Pat. No. 4,442,187 discloses a battery which has a positive electrode or a negative electrode formed of the conductive polymer compound. Since the conductive polymer compound is composed of light elements such as carbon and nitrogen, the battery is expected to achieve large capacity. However, the exitons generated through the oxidation-reduction are delocalized in the π electron conjugate system, and they interact each other. This results in a limit to the concentration of exitons, and the battery can not sufficiently increase the capacity.

As described hereinbefore, research and development efforts have been made on a large energy density and large capacity stable battery without using the heavy metal oxides. The prior art batteries are fairly reduced in weight. However, the prior art batteries do not satisfy the user. The prior art batteries are still on their way to the large capacity. In other words, any high-energy density, large capacity and stable battery have not been developed.

In summary, the lithium ion batteries reach the limit of the capacity, and the batteries with the conductive polymer compound are still on the way to the technical goal.

### SUMMARY OF THE INVENTION

It is therefore an important object of the present invention to provide a battery, which is high in energy density, large in capacity and stable.

To accomplish the object, the present invention proposes to use new organic compound with a particular structure as active material of battery.

In accordance with one aspect of the present invention, there is provided a battery comprising a positive electrode, a negative electrode and electrolyte, at least one of the positive and negative electrodes including an electrode layer essentially composed of cyclic conjugated carbonyl compound having a structural unit expressed by general formula (1)

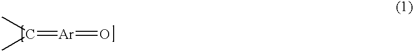

where Ar is an organic group equivalent to a compound selected from the group consisting of aromatic compound having carbon number 5 to 14 from which two hydrogen atoms are eliminated and substituted compound of said aromatic compound from which two hydrogen atoms are eliminated.

### BRIEF DESCRIPTION OF THE DRAWINGS

The features and advantages of the battery will be more clearly understood from the following description taken in conjunction with the accompanying drawings in which:

FIG. 1 is a plane view showing the structure of a battery according to the present invention;

FIG. 2 is a cross sectional view showing the structure of the battery; and

FIG. 3 is a graph showing a charge-discharge profile measured at the battery implementing the first embodiment.

### DESCRIPTION OF THE PREFERRED EMBODIMENTS

Structure of Battery

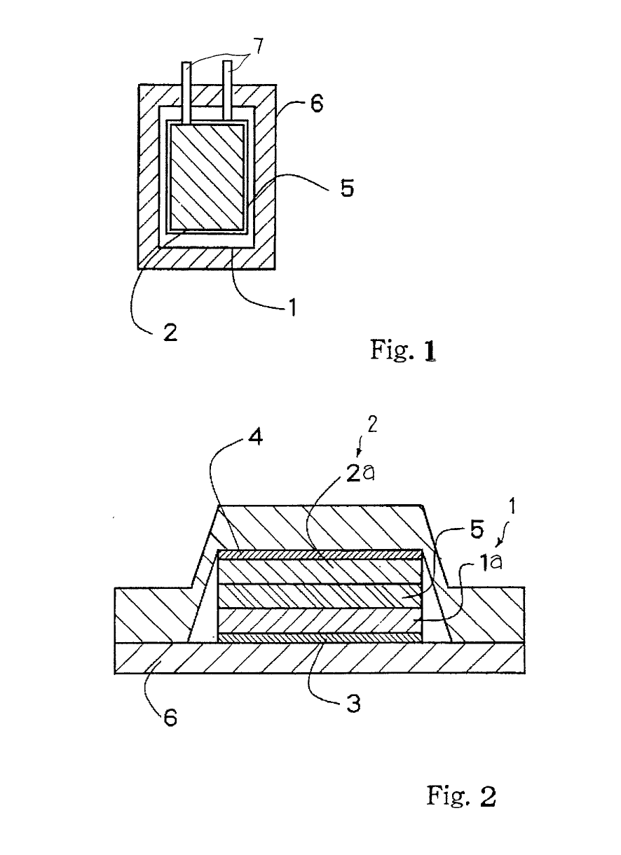

Referring to FIG. 1 of the drawings, a battery embodying the present invention largely comprises a negative electrode 1, a positive electrode 2, a separator 5 containing electrolyte, a package 6 and a pair of terminals 7. The separator 5 is sandwiched between the negative electrode 1 and the positive electrode 2. The negative electrode 1, the positive electrode 2 and the separator 5 are sealed in the package 6, and the terminals 7 project from the negative/positive electrodes 1/2 through the package 6.

As shown in FIG. 2, the negative electrode 1 has a negative electrode layer 1a and a current collector 3 connected to each other. On the other hand, the positive electrode 2 has a positive electrode layer 2a and a current collector 4 connected to each other. The separator 5 is sandwiched between the negative electrode layer 1a and the positive electrode layer 2a. At least one of the negative electrode layer 1a, positive electrode layer 2a and separator 5 contains cyclic conjugated carbonyl compound as active material. It is preferable that the battery shown in FIGS. 1 and 2 is a lithium secondary battery from the viewpoint of the capacity.

Active Material

The active material used in the battery directly participates in the electrode reaction such as the charging reaction and the discharging reaction, and is the essential part of the battery system. The active material may be solid, or dissolved or dispersed in electrolyte.

The active material contains the cyclic conjugated carbonyl compound, the structural unit of which is expressed by general formula (1).

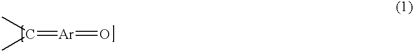

where Ar is an organic group equivalent to aromatic compound having carbon number 5 to 14 from which two hydrogen atoms are eliminated or substituted compound of the aromatic compound from which two hydrogen atoms are eliminated.

The carbonyl compound has a large energy density per unit mass, and is appropriate for the active material of the stable battery.

It is preferable that the cyclic conjugated carbonyl compound has the structural unit expressed by one of the general formulae (2) and (3) or the structural units respectively expressed by the general formulae (2) and (3).

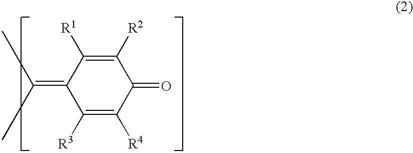

where substituents R¹ to R⁴ are independent of one another, each of the substituents R¹ to R⁴ is selected from the group consisting of hydrogen, halogen atoms, hydroxyl group, nitro group, nitroso group, cyano group, carboxyl group, alkyl group, substituted alkyl group, alkenyl group, substituted alkenyl group, cycloalkyl group, substituted cycloalkyl group, aryl group, substituted aryl group, aralkyl group, substituted aralkyl group, amino group, substituted amino group, alkoxy group, substituted alkoxy group, aryloxy group, substituted aryloxy group, alkoxycarbonyl group, substituted alkoxycarbonyl group, aryloxycarbonyl group, substituted aryloxycarbonyl group, acyl group and substituted acyl group, each of the above-described groups may have sulfur atom, silicon atom, phosphorous atom or boron atom substituted for at least one atom thereof, and the substituents adjacent to one another may form a ring structure.

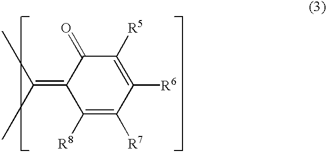

where substituents R⁵-R⁸ are same as R¹-R⁴ of general formula (2). The structural unit expressed by general formula (2) or (3) is composed of low-mass elements such as carbon, hydrogen and oxygen. For this reason, the battery using the cyclic conjugated carbonyl compound with the structural unit as active material of the electrode achieves a large energy density per unit mass.

It is preferable that the cyclic conjugated carbonyl compound is expressed by general formulae (4) or (5).

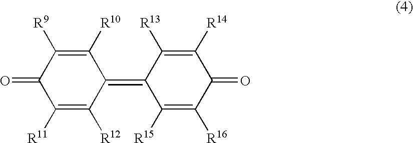

where substituents R⁹-R¹⁶ are same as R¹-R⁴ of general formula (2).

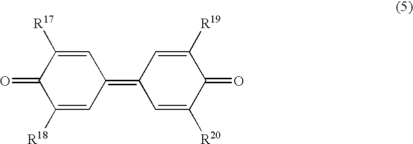

where substituents R¹⁷-R²⁰ are independent of one another, and each of the substituents R¹⁷-R²⁰ is alykyl group having carbon number 1 to 6. The cyclic conjugated carbonyl compound expressed by general formula (4) or (5) is composed of low-mass elements such as carbon, hydrogen and oxygen. For this reason, the battery using the compound as active material of the electrode achieves a large energy density per unit mass.

It is preferable that the cyclic conjugated carbonyl compound is expressed by any one of general formulae (6) to (8)

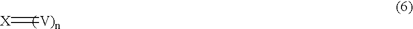

where X is organic group equivalent to aromatic compound having carbon number 5-30 from which n hydrogen atoms are eliminated or substituted compound of the aromatic compound from which n hydrogen atoms are eliminated, V is the structural unit expressed by general formula (9), X is bonded to n structural units V independent of one another, and n is an integer from 2 to 6.

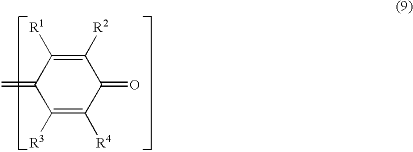

where R¹ to R⁴ are same as those in general formula (2).

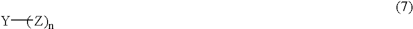

where Y is n-valent organic group equivalent to chain hydrocarbon compound having carbon number 1 to 5 from which n hydrogen atoms are eliminated, substituted compound of the chain hydrocarbon compound from which n hydrogen atoms are eliminated, cyclic hydrocarbon compound having carbon number 3 to 30 from which n hydrogen atoms are eliminated or substituted compound of the cyclic hydrocarbon compound from which n hydrocarbons are eliminated or the hydrocarbon compound in which oxygen atom, nitrogen atom, sulfur atom, silicon atom, phosphorous atom or boron atom may be substituted for at least one carbon atom thereof, or bivalent sulfur atom; Z is the structural unit expressed by general formula (10); Y is bonded to the n structural units Z independent of one another; and n is an integer from 2 to 6.

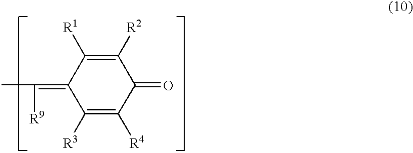

where R¹ to R⁴ are same as those in general formula (9), and substituent R⁹ is a monovalent organic group same as the substituent in general formula (2).

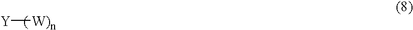

where Y is same as that in general formula (7), W is the structural unit expressed by general formula (11), Y is bonded to the n structural units W independent of one another and n is an integer from 2 to 6.

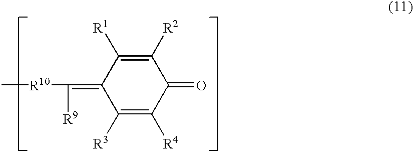

where R¹ to R⁴ and R⁹ are same as those in general formula (10); and R¹⁰ is a divalent organic group equivalent to a compound which is selected from the group consisting of substituted/non-substituted aliphatic hydrocarbon compounds, substituted/non-substituted aromatic hydrocarbon compounds, substituted/non-substituted amine compounds, substituted/non-substituted ether compounds, substituted/non-substituted ester compounds, substituted/non-substituted ketone compounds, substituted/non-substituted amido compounds, substituted/non-substituted compounds each having any one of the combinations of the functional groups contained in the substituted/non-substituted aliphatic hydrocarbon compounds, the substituted/non-substituted aromatic hydrocarbon compounds, the substituted/non-substituted amine compounds, the substituted/non-substituted ether compounds, the substituted/non-substituted ester compounds, the substituted/non-substituted ketone compounds and the substituted/non-substituted amido compounds and from which two hydrogen atoms are eliminated and in which oxygen atom, nitrogen atom, sulfur atom, silicon atom, phosphorous atom or boron atom may be substituted for at least one atom contained therein.

The cyclic conjugated carbonyl compound expressed by any one of equations (6) to (8) includes plural cyclohexadienonyliden structural units in the molecule so that the oxidation/reduction reaction takes place at high efficiency.

It is preferable that the cyclic conjugated carbonyl compound is a polymer compound which has the structural unit expressed by any one of general formulae (12) to (16).

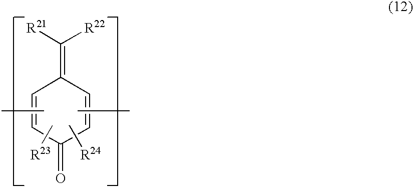

where substituents R²¹ to R²⁴ are same as the substituents R¹ to R⁴ in the general formula (2).

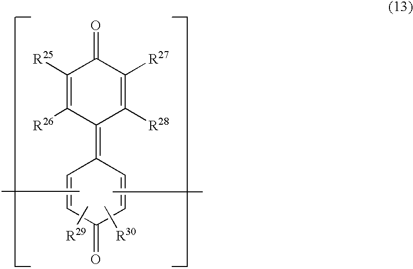

where substituents R²⁵ to R³⁰ are the substituents R¹ to R¹ in the general formula (2).

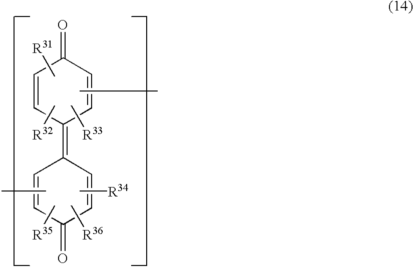

where substituents R³¹ to R³⁶ are same as the substituents R¹ to R⁴.

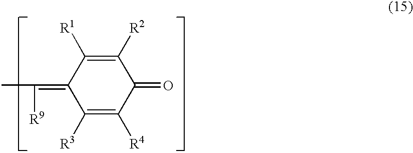

where substituents R¹ to R⁴ and R⁹ are same as those in the general formula

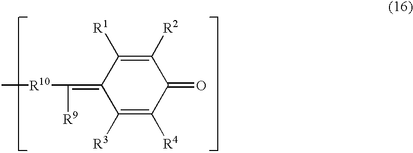

where R¹ to R⁴, R⁹ and R¹⁰ are same as those in the general formula (11).

The cyclic conjugated carbonyl compound expressed by any one of the general formulae (12) to (16) includes the cyclohexadienonylidene structural unit in the polymer so that the oxidation and reduction reaction efficiently proceeds and the cycle characteristics do not depend on the diffusion of the active material. For this reason, the battery is stable.

It is preferable that the cyclic conjugated carbonyl compound serves as the active material in the positive electrode, because the battery exhibits a high energy density and a large capacity.

It is preferable that the battery according to the present invention is a lithium secondary battery. Then, the battery is stable, and exhibits a large capacity.

Cyclic Conjugated Carbonyl Compound

As described hereinbefore, the cyclic conjugated carbonyl compound includes the structural unit expressed by the general formula (1), and it is preferable that the structural unit is expressed by both of or any one of the general formulae (2) and (3). Nevertheless, the general formulae (2) and (3) do not set any limit on the cyclic conjugated carbonyl compound. The low-molecular weight compounds expressed by the general formulae (4) to (8) are examples of the cyclic conjugated carbonyl compound, and the high-molecular weight compounds expressed by the general formulae (12) to (16) are other examples of the cyclic conjugated carbonyl compound. The active material may contain more than one kind of the cyclic conjugated carbonyl compound. The structural unit is hereinafter described in detail.

Substituents

As described hereinbefore, halogen atom may be the substituents R¹ to R⁸ in the general formulae (2) and (3) and the substituent R⁹ in the general formula (10). The halogen atom is selected from the group consisting of fluorine, chlorine, bromine, iodine and any combination of more than one halogen atoms.

Examples of substituted/non-substituted alkyl groups are methyl group, ethyl group, propyl group, isopropyl group, n-butyl group, s-butyl group, isobutyl group, t-butyl group, n-pentyl group, n-hexyl group, n-heptyl group, n-octyl group, hydroxymethyl group, 1-hydroxyethyl group, 2-hydroxyethyl group, 2-hydroxyisobutyl group, 1,2-dihydroxyethyl group, 1,3-dihydroxyisopropyl group, 2,3-dihydroxy-t-butyl group, 1,2,3-trihydroxypropy group, chloromethyl group, 1-chloroethyl group, 2-chloroethyl group, 2-chloroisobutyl group, 1,2-dichloroethyl group, 1,3-dichloro-isopropyl group, 1,1-bis(chloromethyl)ethyl group, 1,2,3-trichloropropyl group, bromomethyl group, 1-bromoethyl group, 2-bromoethyl group, 2-bromoisobutyl group, 1,2-dibromoethyl group, 1,3-dibromoisopropyl group, 2,3-dibromo-t-butyl group, 1,2,3-tribromopropyl group, iodomethyl group, 1-iodoethyl group, 2-iodoethyl group, 2-iodoisobutyl group, 1,2-diiodoethyl group, 1,3-diiodoisopropyl group, 2,3-diiodo-t-butyl group, 1,2,3-triiodopropyl group, aminomethyl group, 1-aminoethyl group, 2-aminoethyl group, 2-aminoisobutyl group, 1,2-diaminoethyl group, 1,3-diaminoisopropyl group, 2,3-diamino-t-butyl group, 1,2,3-triaminopropyl group, cyanomethyl group, 1-cyanoethyl group, 2-cyanoethyl group, 2-cyanoisobutyl group, 1,2-dicyanoethyl group, 1,3-dicyanoisopropyl group, 2,3-dicyano-t-butyl group, 1,2,3-tricyanopropyl group, nitromethyl group, 1-nitroethyl group, 2-nitroethyl group, 2-nitroisobutyl group, 1,2-dinitroethyl group, 1,3-dinitroisopropyl group, 2,3-dinitro-t-butyl group and 1,2,3-trinitropropyl group. More than one group may be simultaneously used.

Examples of substituted/non-substituted alkenyl groups are vinyl group, allyl group, 1-butenyl group, 2-butenyl group, 3-butenyl group, 1,3-butandienyl group, 1-methylvinyl group, styryl group, 2,2-diphenylvinyl group, 1,2-diphenylvinyl group, 1,2-diphenylvinyl group, 1-methylallyl group, 1,1-dimethylallyl group, 2-methylallyl group, 1-phenylallyl group, 2-phenylallyl group, 3-phenylallyl group, 3,3-diphenylallyl group, 1,2-dimethylallyl group, 1-phenyl-1-butenyl group and 3-phenyl-1-butenyl group. More than one group may be simultaneously used.

Examples of substituted/non-substituted cycloalkyl groups are cyclopropyl group, cyclobutyl group, cyclopentyl group, cylcohexyl group and 4-methylcyclohexyl group. More than one group may be simultaneously used.

Examples of substituted/non-substituted aryl groups are phenyl group, 1-naphtyl group, 2-naphthyl group, 9-fluorenyl group, 1-anthryl group, 2-anthryl group, 9-anthryl group, 1-phenanthryl group, 2-phenanthryl group, 3-phenanthryl group, 4-phenanthryl group, 9-phenanthryl group, 1-naphthasenyl group, 2-naphthasenyl group, 9-naphthasenyl group, 1-pyrenyl group, 2-pyrenyl group, 4-pyrenyl group, 2-biphenylil group, 3-biphenylil group, 4-biphenylil group, p-terphenyl-4-il group, p-terphenyl-3-il group, p-terphenyl-2-il group, m-terphenyl-4-il group, m-terphenyl-3-il group, m-terphenyl-2-il group, o-tolyl group, m-tolyl group, p-tolyl group, p-t-butylphenyl group, p-(2-phenylpropyl)phenyl group, 3-methyl-2-naphthyl group, 4-methyl-1-naphthyl group, 4-methyl-1-anthryl group, 4′-methylbiphenylil group, 4″-t-butyl-p-terphenyl-4-il group, 1-pyrolyl group, 2-pyrolyl group, 3-pyrolyl group, pyrazinyl group, 2-pyridinyl, 3-pyridinyl group, 4-pyridinyl group, 1-indolyl group, 2-indolyl group, 3-indolyl group, 4-indolyl group, 5-indolyl group, 6-indolyl group, 7-indolyl group, 1-isoindolyl group, 2-isoindolyl group, 3-isoindolyl group, 4-isoindolyl group, 5-isoindolyl group, 6-isoindolyl group, 7-isoindolyl group, 2-furil group, 3-furil group, 2-benzofuranyl group, 3-benzofuranyl group, 4-benzofuranyl group, 5-benzofuranyl group, 6-benzofuranyl group, 7-benzofuranyl group, 1-isobenzofuranyl group, 6-isobenzofuranyl group, 4-isobenzofuranyl group, 5-isobenzofuranyl group, 6-isobenzofuranyl group, 7-isobenzofuranyl group, 2-quinolyl group, 3-quinolyl group, 4-quinolyl group, 5-quinolyl group, 6-quinolyl group, 7-quinolyl group, 8-quinolyl group, 1-isoquinolyl group, 3-isoquinolyl group, 4-isoquinolyl group, 5-isoquinolyl group, 6-isoquinolyl group, 7-isoquinolyl group, 8-isoquinolyl group, 2-quinoxalinyl group, 5-quinoxalinyl group, 6-quinoxalinyl group, 1-carbazolyl group, 2-carbazolyl group, 3-carbazolyl group, 4-carbazolyl group, 9-carbazolyl group, 1-phenanthridinyl group, 2-phenanthridinyl group, 3-phenanthridinyl group, 4-phenanthridinyl group, 6-phenanthridinyl group, 7-phenanthridinyl group, 8-phenanthridinyl group, 9-phenanthridinyl group, 10-phenanthridinyl group, 1-acridinyl group, 2-acridinyl group, 3-acridinyl group, 4-acridinyl group, 9 acridinyl group, 1,7-phenanthroline-2-il group, 1,7-phenanthroline-3-il group, 1,7-phenanthroline-4-il group, 1,7-phenanthroline-5-il group, 1,7-phenanthroline-6-il group, 1,7-phenanthroline-8-il group, 1,7-phenan-throline-9-il group, 1,7-phenanthroline-8-il group, 1,8-phenanthroline-2-il group, 1,8-phenanthroline-3-il group, 1,8-phenanthroline-4-il group, 1,8-phenanthroline-5-il group, 1,8-phenanthroline-6-il group, 1,8-phenanthroline-7-il group, 1,8-phenanthroline-9-il group, 1,8-phenanthroline-10-il group, 1,9-phenanthroline-2-il group, 1,9-phenanthroline-3-il group, 1,9-phenanthroline-4-il group, 1,9-phenanthroline-5-il group, 1,9-phenan-throline-6-il group, 1,9-phenanthroline-7-il group, 1,9-phenanthroline-8-il group, 1,9-phenanthroline-10-il group, 1,10-phenanthroline-2-il group, 1,10-phenanthroline-3-il group, 1,10-phenanthroline-4-il group, 1,10-phenanthroline-5-il group, 2,9-phenanthroline-1-il group, 2,9-phenanthroline-3-il group, 2,9-phenanthroline-4-il group, 2,9-phenanthroline-5-il group, 2,9-phenanthroline-6-il group, 2,9-phenanthroline-7-il group, 2,9-phenanthroline-8-il group, 2,9-phenanthroline-10-il group, 2,8-phenanthroline-1-il group, 2,8-phenanthroline-3-il group, 2,8-phenanthroline-4-il group, 2,8-phenanthroline-5-il group, 2,8-phenanthroline-6-il group, 2,8-phenanthroline-7-il group, 2,8-phenanthroline-9-il group, 2,8-phenanthroline-10-il group, 2,7-phenanthroline-1-il group, 2,7-phenanthroline-3-il group, 2,7-phenanthroline-4-il group, 2,7-phenanthroline-5-il group, 2,7-phenanthroline-6-il group, 2,7-phenanthroline-8-il group, 2,7-phenanthroline-9-il group, 2,7-phenanthroline-10-il group, 1-phenazinyl group, 2-phenazinyl group, 1-phenothiazinyl group, 2-phenothiazinyl group, 3-phenothiazinyl group, 4-phenothiazinyl group, 10-phenothiazinyl group, 1-phenoxazinyl group, 2-phenoxazinyl group, 3-phenoxazinyl group, 4-phenoxazinyl group, 10-phenoxazinyl group, 2-oxazolyl group, 4-oxazolyl group, 5-oxazolyl group, 2-oxadiazolyl group, 5-oxadiazolyl group, 3-furazanyl, 2-thienyl group, 3-thienyl group, 2-methylpyrrole-1-il group, 2-methylpyrrole-3-il group, 2-methylpyrrole-4-il group, 2-methylpyrrole-5-il group, 3-methylpyrrole-1-il group, 3-methylpyrrole-2-il group, 3-methylpyrrole-4-il group, 3-methylpyrrole-5-il group, 2-t-butylpyrrole-4-il group, 3-(2-phenylpropyl)pyrrole-1-il group, 2-methyl-i-indolyl group, 4-methyl-1-indolyl group, 2-methyl-3-indolyl group, 4-methyl-3-indolyl group, 2-t-butyl-1-indolyl group, 4-t-butyl-1-indolyl group, 2-t-butyl-3-in-dolyl group and 4-t-butyl-3-indolyl group. More than one group may be simultaneously used.

Examples of substituted/non-substituted aralkyl groups are benzyl group, 1-phenylethyl group, 2-phenylethyl group, 1-phenylisopropyl group, 2-phenylisopropyl group, phenyl-t-butyl group, α-naphtyl group, 1-α-naphthylethyl group, 2-α-naphthylethyl group, 1-α-naphthylisopropyl group, 2-α-naphthylisopropyl group, β-naphthylmethyl group, 1-β-naphthylethyl group, 2-β-naphthylethyl group, 1-β-naphthylisopropyl group, 2-β-naphthylisopropyl group, 1-pyrolylmethyl group, 2-(1-pyrolyl)ethyl group, p-methylbenzyl group, m-methylbenzyl group, o-methylbenzyl group, p-chlorbenzyl group, m-chlorbenzyl group, o-chlorbenzyl group, p-bromobenzyl group, m-bromobenzyl group, o-bromobenzyl group, p-iodobenzyl group, m-iodobenzyl group, o-iodobenzyl group, p-hydroxybenzyl group, m-hydroxybenzyl group, o-hydroxybenzyl group, p-aminobenzyl group, m-aminobenzyl group, o-aminobenzyl group, p-nitrobenzyl group, m-nitrobenzyl group, o-nitrobenzyl group, p-cyanobenzil group, m-cyanobenzyl group, o-cyanobenzyl group, 1-hygroxy-2-phenylisopropyl group and 1-chlor-2-phenylisopropyl group. More than one group may be simultaneously used.

The substituted/non-substituted amino groups are expressed as —NX¹X². Substituents X¹ and X² are independent of each other, and each of X¹ and X² is hydrogen, the above-mentioned substituted/non-substituted alkyl group, the above-mentioned substituted/non-substituted alkenyl group, the above-mentioned substituted/non-substituted cycloalkyl group, the above-mentioned substituted/non-substituted aryl group or above-mentioned substituted/non-substituted aralkyl group. More than one element and/or group may be simultaneously used therein.

The substituted/non-substituted alkoxy groups are expressed as —OX³, and the substituted/non-substituted alkoxycarbonyl groups are expressed as —COOX⁴. Examples of the substituents X³ and X⁴ are the above-mentioned substituted/non-substituted alkyl groups, the above-mentioned substituted/non-substituted cycloalkyl groups and the above-mentioned substituted/non-substituted aralkyl groups.

The substituted/non-substituted aryloxy groups are expressed as —OX⁵, and the substituted/non-substituted aryloxycarbonyl groups are expressed as —COOX⁶. Examples of the substituents X⁵ and X⁶ are above-mentioned substituted/non-substituted aryl groups.

The substituted/non-substituted acyl groups are expressed as —C(═O)X⁷, and examples of the substituent X⁷ are hydrogen, the above-mentioned substituted/non-substituted alkyl groups, the above-mentioned substituted/non-substituted alkenyl groups, the above-mentioned substituted/non-substituted cycloalkyl groups, the above-mentioned substituted/non-substituted aryl groups and the above-mentioned substituted/non-substituted aralkyl groups.

The general formula (6) has the substituent X, and substituent X is the organic group equivalent to aromatic compound from which n hydrogen atoms are eliminated or substituted aromatic compound from which n hydrogen atoms are eliminated. Examples of the substituted/non-substituted aromatic compounds are benzene, naphthalene, anthracene, phenanthrene, triphenylene, pyrene, chrysene, naphthacene, picene, perylene, pentaphene, pentacene, hexacene, hexaphene, coronene, trinaphthylene, heptaphene, heptacene, thiophene, thiansulene, furan, pyran, pyrrole, pyridine, pyrazine, pyrimidine, pyridazine, indole, quinoline, isoquinoline, phthalazine, naphthyridine, quinoxaline, carbazole, phenanthridine, acridine, phenazine, phenanthroline and phenoxazine.

The general formulae (7) and (8) have the substituent Y, and the substituent Y is the n-valent organic group equivalent to the chain hydrocarbon compound having carbon number 1 to 5 from which n hydrocarbons are eliminated and in which oxygen atom, nitrogen atom, sulfur atom, silicon atom, phosphorous atom or boron atom may be substituted for at least one carbon atom thereof. Examples of the substituted/non-substituted chain hydrocarbon compounds are methane, ethane, ethylene, propane, propene, n-butane, iso-butane, 1-butene, 2-butene, 1,3-butadiene, 1-butin, 2-butin, n-pentane, isopentane, neopentane, 1-pentene, 2-pentene, 1,3-pentadiene, 1,4-pentadiene, 1-pentyne and 2-pentyne.

Otherwise, the n-valent organic group is equivalent to the substituted/non-substituted cyclic hydrocarbon compounds having carbon number 3 to 30 from which n hydrocarbons are eliminated and in which oxygen atom, nitrogen atom, sulfur atom, silicon atom, phosphorous atom or boron atom may be substituted for at least one carbon atom thereof. Examples of the substituted/non-substituted cyclic hydrocarbon compounds are cyclopropane, cyclobutane, cyclopentane, cyclopentene, cyclopentadiene, cyclohexane, cyclohexene, cyclohexadiene, spiro[3,3]heptane, spiro[3,4]octane, spiro[4,4]nonane, spiro[4,5]decane, spiro[5,5]undecane, spiro[5,6]dodecane, Spiro[6,6]tridecane, benzene, naphthalene, anthracene, phenanthrene, triphenylene, pyrene, chrysene, naphthacene, picene, perylene, pentaphene and pentacene. Examples of the derivative of the cyclic hydrocarbon compound are cyclobutanone, cyclopentanone, cyclohexanone, cyclohexanedion, cyclohexadienone and cyclohexantrione.

The general formula (11) has the substituent R¹⁰, and the R¹⁰ represents the bivalent organic groups described hereinbefore. The bivalnet organic group is, by way of example, equivalent to the aliphatic hydrocarbon compound from which two hydrogen atoms are eliminated and in which oxygen atom, nitrogen atom, sulfur atom, silicon atom, phosphorous atom or boron atom may be substituted for at least one carbon atom thereof or the substituted aliphatic hydrocarbon compound from which two hydrogen atoms are eliminated and in which oxygen atom, nitrogen atom, sulfur atom, silicon atom, phosphorous atom or boron atom may be substituted for at least one carbon atom thereof. Examples of the bivalent organic groups relating to the substituted/non-substituted aliphatic hydrocarbon compounds are equivalent to substituted/non-substituted alkyl groups and substituted/non-substituted cycloalkyl groups each further eliminated a hydrogen atom.

Otherwise, the bivalent organic group is equivalent to the aromatic hydrocarbon compound from which two hydrogen atoms are eliminated and in which oxygen atom, nitrogen atom, sulfur atom, silicon atom, phosphorous atom or boron atom may be substituted for at least one carbon atom thereof or the substituted aromatic hydrocarbon compound from which two hydrogen atoms are eliminated and in which oxygen atom, nitrogen atom, sulfur atom, silicon atom, phosphorous atom or boron atom may be substituted for at least one carbon atom thereof. Examples of the bivalent organic groups relating to the substituted/non-substituted aromatic hydrocarbon compounds are benzene, naphthalene, anthracene, phenanthrene, triphenylene, pyrene, chrysene, naphthacene, picene, perylene, pentaphene, pentacene, thiophene, thianthrene, furan, pyran, pyrrole, pyridine, pyrazine, pyrimidine, pyridazine, indole, quinoline, isoquinoline, phthalazine, naphthyridine, quinoxaline, carbazole, phenanthridine, acridine, phenazine, phenanthroline and phenoxazine each eliminated two hydrogen atoms.

Otherwise, the bivalent organic group is equivalent to the amine compound from which two hydrogen atoms are eliminated and in which oxygen atom, nitrogen atom, sulfur atom, silicon atom, phosphorous atom or boron atom may be substituted for at least one carbon atom thereof or the substituted amine compound from which two hydrogen atoms are eliminated and in which oxygen atom, nitrogen atom, sulfur atom, silicon atom, phosphorous atom or boron atom may be substituted for at least one carbon atom thereof. The bivalent organic groups relating to the substituted/non-substituted amine compounds are expressed as —NX⁸—. Examples of the substituent X⁸ are the above-mentioned substituted/non-substituted alkyl groups, the substituted/non-substituted alkenyl groups, the substituted/non-substituted cycloalkyl groups, the substituted/non-substituted aryl groups, the substituted/non-substituted aralkyl groups.

Otherwise, the bivalent organic group is equivalent to the ether compound from which two hydrogen atoms are eliminated and in which oxygen atom, nitrogen atom, sulfur atom, silicon atom, phosphorous atom or boron atom may be substituted for at least one carbon atom thereof or the substituted ether compound from which two hydrogen atoms are eliminated and in which oxygen atom, nitrogen atom, sulfur atom, silicon atom, phosphorous atom or boron atom may be substituted for at least one carbon atom thereof. The bivalent organic groups relating to the substituted/non-substituted ether compounds are expressed as —X⁹OX¹⁰—. The substituents X⁹ and X¹⁰ are independent of one another. Examples of the substituents X⁹/X¹⁰ are the above-mentioned substituted/non-substituted alkyl groups, substituted/non-substituted alkenyl groups, substituted/non-substituted cycloalkyl groups, substituted/non-substituted aryl groups, substituted/non-substituted aralkyl groups and combinations each containing at least one of these groups.

Otherwise, the bivalent organic group is equivalent to the ester compound from which two hydrogen atoms are eliminated and in which oxygen atom, nitrogen atom, sulfur atom, silicon atom, phosphorous atom or boron atom maybe substituted for at least one carbon atom thereof or the substituted ester compound from which two hydrogen atoms are eliminated and in which oxygen atom, nitrogen atom, sulfur atom, silicon atom, phosphorous atom or boron atom may be substituted for at least one carbon atom thereof. The bivalent organic groups relating to the substituted/non-substituted ester compounds are expressed as —X¹¹C(═O)OX¹²—or —C(═O)OX¹²—. The substituents X¹¹ and X¹² are independent of one another. Examples of the substituents X¹¹/X¹² are the above-mentioned substituted/non-substituted alkyl groups, substituted/non-substituted alkenyl groups, substituted/non-substituted cycloalkyl groups, substituted/non-substituted aryl groups, substituted/non-substituted aralkyl groups and combinations each containing at least one of these groups.

Otherwise, the bivalent organic group is equivalent to the ketone compound from which two hydrogen atoms are eliminated and in which oxygen atom, nitrogen atom, sulfur atom, silicon atom, phosphorous atom or boron atom may be substituted for at least one carbon atom thereof or the substituted ketone compound from which two hydrogen atoms are eliminated and in which oxygen atom, nitrogen atom, sulfur atom, silicon atom, phosphorous atom or boron atom may be substituted for at least one carbon atom thereof. The bivalent organic groups relating to the substituted/non-substituted ketone compounds are expressed as —X¹³C(═O)X¹⁴. The substituents X¹³ and X¹⁴ are independent of one another. Examples of the substituents X¹³/X¹⁴ are the above-mentioned substituted/non-substituted alkyl groups, substituted/non-substituted alkenyl groups, substituted/non-substituted cycloalkyl groups, substituted/non-substituted aryl groups, substituted/non-substituted aralkyl groups and combinations each containing at least one of these groups.

Otherwise, the bivalent organic group is equivalent to the amido compound from which two hydrogen atoms are eliminated and in which oxygen atom, nitrogen atom, sulfur atom, silicon atom, phosphorous atom or boron atom may be substituted for at least one carbon atom thereof or the substituted amido compound from which two hydrogen atoms are eliminated and in which oxygen atom, nitrogen atom, sulfur atom, silicon atom, phosphorous atom or boron atom may be substituted for at least one carbon atom thereof. The bivalent organic groups relating to the substituted/non-substituted amido compounds are expressed as —NX¹⁵—C(═O)X¹⁶. The substituents X¹⁵ and X¹⁶ are independent of one another. Examples of the substituents X¹⁵/X¹⁶ are the above-mentioned substituted/non-substituted alkyl groups, substituted/non-substituted alkenyl groups, substituted/non-substituted cycloalkyl groups, substituted/non-substituted aryl groups, substituted/non-substituted aralkyl groups and combinations each containing at least one of these groups. The substituent X¹⁵ may be hydrogen atom.

Process

There is not any limit on a process for producing the cyclic conjugated carbonyl compound. The cyclic conjugated carbonyl compound is, by way of example, produced by dropping water solution of sodium hydroxide containing potassium hexacyanoferrate (III) into solution of chloroform containing phenol compound. Upon completion of the reaction, it is preferable to refine the reaction product through a column chromatography so as to separate the cyclic conjugated carbonyl compound from by-product.

### EXAMPLES

Examples of the cyclic conjugated carbonyl compound used in the battery according to the present invention are expressed by structural formulae (17) to (38).

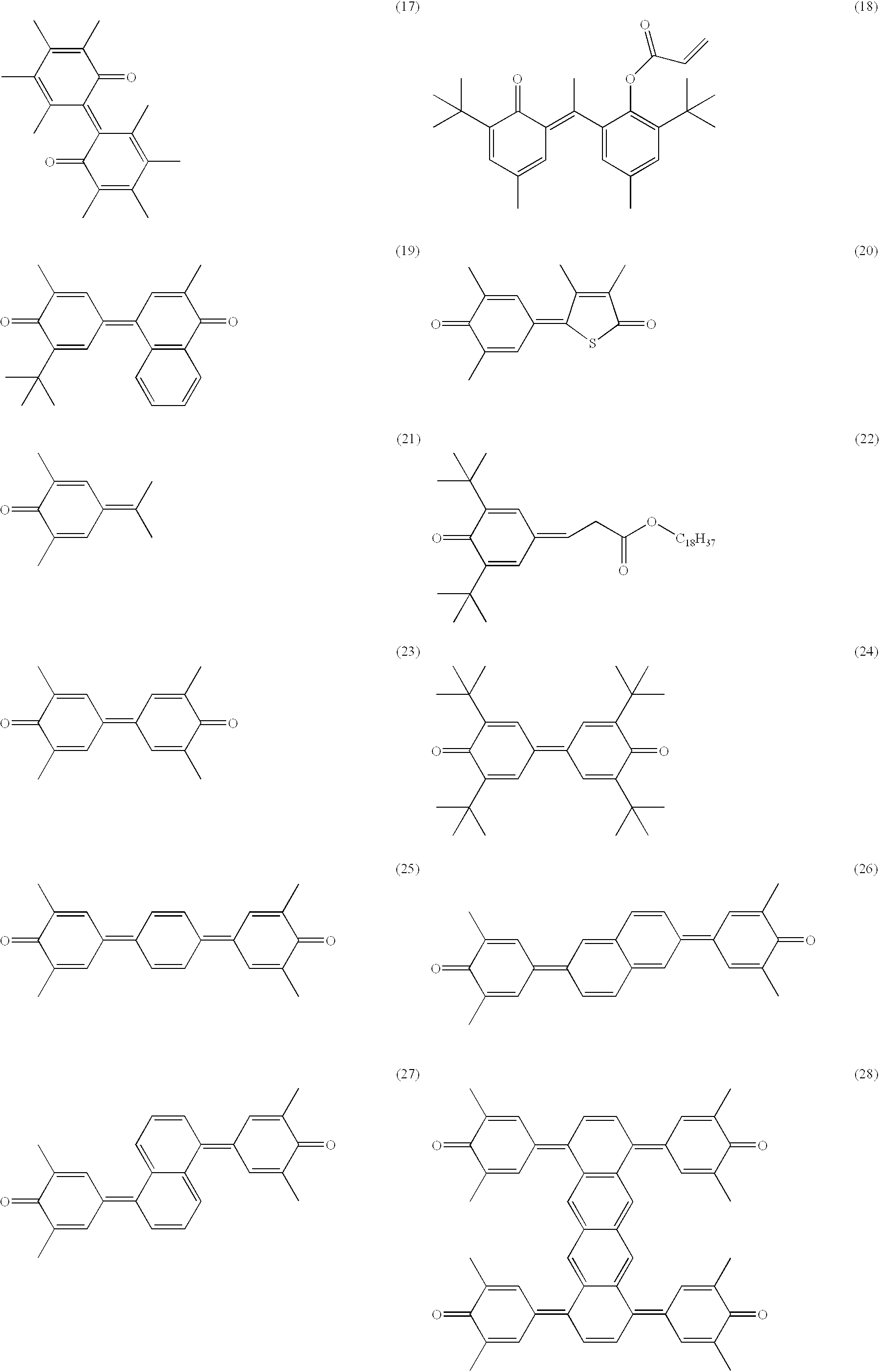

Material for Other Electrode

The cyclic conjugated carbonyl compound is used in both of the negative electrode 1 and the positive electrode 2, or is used in one of the negative electrode 1 and the positive electrode 2. The cyclic conjugated carbonyl compound is smaller in mass than the conventional active material in the metal oxide series, and is larger in energy density than the conventional active material in the metal oxide series. For this reason, it is preferable to use the cyclic conjugated carbonyl compound in the positive electrode 2 as the active material.

In case, where the cyclic conjugated carbonyl compound is used in one of the negative electrode 1 and the positive electrode 2 as the active material, the other electrode 2 or 1 may contain the following active material.

The negative electrode layer 1a is assumed to contain the cyclic conjugated carbonyl compound, the active material in the positive electrode layer 2a may be metal oxide grains, disulfide compound or conductive polymer compound. Examples of the metal oxide are lithium manganese oxide such as, for example, LiMnO₂, LiₓMn₂O₄ where x is greater than zero and less than 2, lithium manganese oxide spinel, MnO₂, LiCoO₂, LiNiO₂ and LiₓV₂O₅ where x is greater than zero and less than 2. Examples of the disulfide compound are dithiogylcol, 2,5-dimercapto-1,3,4-thiadiazole and S-triazine-2,4,6-trithiol. Examples of conductive polymer compound are polyacetylene, polyphenylene, polyaniline and polypyrrole. More than one kind of the active material described hereinbefore may be simultaneously used in the positive electrode layer 2a. At least one kind of the active material may be mixed with the cyclic conjugated carbonyl compound in the positive electrode layer 2a.

On the other hand, in case where the positive electrode layer 2a contains the cyclic conjugated carbonyl compound, the active material in the negative electrode 1 may be graphite, amorphous carbon, lithium metal, lithium alloy, lithium ion insertion carbon, conductive polymer compound or mixture containing more than one kind of the above-described active material. These kinds of conventional active material are provided in an arbitrary shape. The lithium metal is, by way of example, provided in the form of thin section, bulk, solidified powder, fiber or flake. At least one kind of the active material may be mixed with the cyclic conjugated carbonyl compound in the negative electrode layer 1a.

Conductive Adjuvant and Ionic Conduction Adjuvant

When the negative/positive electrode layer or layers 1a/2a are formed from the cyclic conjugated carbonyl compound, conductive adjuvant and/or ion conduction adjuvant may be mixed with the cyclic conjugated carbonyl compound for reducing the impedance. Examples of the conductive adjuvant are carbonaceous fine grain such as, for example, graphite, carbon black and acetylene black, and conductive polymer compound such as, for example, polyaniline, polypyrrole, polythiophene, polyacetylene and polyacene. Examples of the ionic conduction adjuvant are gel-electrolyte and solid electrolyte.

Binder

The positive/negative electrode layer or layers may further contain binder so as to bind the cyclic conjugated carbonyl compound with the other materials such as the conductive adjuvant and/or the ionic conduction adjuvant. An examples of the binder is resin binder such as, for example, polyfluorovinylidene, vinylidenefluoride-hexfluoropropylene copolymer, vinylidenefluoride-tetrafluoroethylene copolymer, styrene-butadiene copolymerized rubber, polytetrafluoroethylene, polypropylene, polyethylene and polyimide.

Catalyst

The negative/positive electrode layer or layers 1a/2a may further contain catalyst in order to increase the rate of the electrode reaction. Examples of the catalyst are conductive polymer compound such as, for example, polyaniline, polypyrrole, polythiophene, polyacetylene and polyacene, basic compound such as, for example, pyridine derivative, pyrrolidone derivative, benzimidazole derivative, benzthiazole derivative and acridine derivative, and metal ion complex.

Current Collector

The negative/positive electrode layers 1a/2a form the negative/positive electrodes 1/2 together with the current collectors 3/4. The current collectors 3/4 are provided in the form of metallic foil, metallic plate, conductive mesh and carbon electrode. The metallic foil/metallic plate may be formed of nickel, aluminum, copper, gold, silver, aluminum alloy or stainless steel. The negative current collector 3 and/or positive current collector 4 may have catalytic function. The negative current collector 3 and/or positive current collector 4 may be chemically bonded to the active material. Meanwhile, the separator 5 such as, for example, porous film or non-woven fabric may be provided in order to prevent the negative electrode/positive electrode from contact.

Electrolyte

The separator contains the electrolyte, which is expected to carry electric charge. The electrolyte has the ionic conductivity of the order of 10⁻⁵ to 10⁻¹ S/cm at room temperature. The electrolyte may contain electrolytic salt which is dissolved in solvent. The electrolytic salt may be lithium salt such as, for example, LiClO₄, LiPF₆, LiBF₄, LiCF₃SO₃, Li(CF₃SO₂)₂N, Li(C₂F₅SO₂)₂N, Li(CF₃SO₂)₃C and Li(C₂F₅SO₂)₃C. Examples of the solvent are organic solvent such as, for example, ethylene carbonate, propylene carbonate, dimethyl carbonate, diethyl carbonate, methylethyl carbonate, γ-butyrolactone, tetrahydrofuran, dioxoran, sulforan, dimethylformamido, dimethylacetoamido and N-methyl-2-pyrrolidone. More than one kind of solvent may be blended.

The electrolyte used in the battery according to the present invention may be high-molecular weight compound. The high-molecular weight compound is used in the form of gel, i.e., the high molecular weight compound containing the liquid electrolyte. Otherwise, the high molecular weight compound is available as they are. Examples of the high molecular weight compound are high molecular weight vinilidene fluoride compound series such as, for example, polyvinylidene fluoride, vinylidene fluoride-ethylene copolymer, vinylidene fluoride-monofluoroethylene copolymer, vinylidene fluoride-tri-fluoroethylene copolymer, vinylidene fluoride-tetrafluoroethylene copolymer, vinylidene fluoride-hexafluoropropylene copolymer and vinylidene fluoride-hexafluoropropylene-tetrafluoroethylene copolymer, high molecular weight acrylonitrile compound series such as, for example, acrylonitrile-methylmethacrylate copolymer, acrylonitrile-ethylmethacrylate copolymer, acrylonitrile-methylacrylate copolymer, acrylonitrile-ethylacrylate copolymer, acrylonitrile-methacrylic acid copolymer, acrylonitrile-acrylic acid copolymer and acrylonitrile-vinylacetate copolymer, polyethylene oxide, ethylene oxide-propylene oxide copolymer, acrylate ester of these oxides and methacrylate ester of those oxides. More than one kind of the high molecular weight compound may be mixed

Shape

The battery according to the present invention may be formed in any conventional shape. The battery drawn in FIGS. 1 and 2 has the laminated structure sealed in the package 6. The battery may have a wound structure. The package may be formed of metal or synthetic resin. A laminated film, which is formed from metal, foils such as aluminum foils and synthetic resin films, is available for the package. The battery according to the present invention has the external appearance like a cylinder, box, disc or sheet. These external configurations do not set any limit on the present invention.

Method of Lamination

The negative electrode layer 1a and the positive electrode layer 2a are produced through any conventional laminating process. The negative electrode layer 1a and/or the positive electrode layer 2a may have a multi-layered structure. The negative electrode layer 1a and/or the positive electrode layer 2a may be held in contact with both of the associated current collectors 3/7, and the lamination may be multipled. The lamination may be wound. Any method is available for the lamination.

Fabrication Process

There is not any limit on a process for fabricating the battery according to the present invention. One of the processes available for the fabrication of the battery has the following sequence. First, the solvent is added to the active material so as to obtain slurry. The slurry is spread on the current collectors 3/4, and the separator 5 is sandwiched between the negative electrode 1 and the positive electrode 2. The lamination 1/2/5 per se is used. Otherwise, the lamination 1/2/5 is wound. The lamination 1/2/5 or the wound body is wrapped in the case 6, and the electrolyte is injected thereinto. Thus, the lamination 1/2/5 and the electrolyte is sealed in the case 6.

The cyclic conjugated carbonyl compound is available for the battery as it is. Otherwise, a precursor may be used in the battery according to the present invention. The precursor is changed to the cyclic conjugated carbonyl compound through the electrode reaction.

In order to evaluate the battery according to the present invention, the present inventors produced samples of the battery according to the present invention and comparative samples. However, the samples do not set any limit on the present invention.

First Embodiment

The present inventors produced the first sample and the comparative sample as follows.

Argon atmosphere was created in a dry box equipped with a gas refining system. 60 milligrams of vinylidenefluoride-hexafluoropropylene copolymer was mixed in 140 milligrams of mixture of ethylene carbonate/propylene carbonate containing LiPF₆ as the electrolytic salt at Imole/litter. The ratio of ethylene carbonate to the propylene carbonate was 1:1 in the mixture. Thereafter, 130 grams of tetrahydrofuran was added into the resultant mixture at room temperature so as to obtain gel electrolyte of tetrahydrofuran solution. The tetrahydrofuran solution is a kind of ionic conduction adjuvant.

30 milligrams of the cyclic conjugated carbonyl compound expressed by structural formula (24) was mixed with 60 milligrams of graphite powder. Thereafter, 200 milligrams of the ionic conduction adjuvant, i.e., the gel electrolyte of tetrahydrofuran solution was added to the mixture. 1,000 milligrams of tetrahydrofuran was further mixed thereinto, and the resultant mixture was well mixed until homogenous slurry was obtained. The homogenous slurry was black.

An aluminum foil was prepared. The aluminum foil measured 1.5 centimeters by 1.5 centimeters, and the thickness was 100 microns. A lead wire has been already connected to the aluminum foil. 200 milligrams of the black slurry was dropped onto the surface of the aluminum foil, and was uniformly spread over the surface by using a wire bar. The black slurry thus spread over the aluminum foil was left for 60 minutes at room temperature. The solvent, i.e., tetrahydrofuran was vaporized, and the cyclic conjugated carbonyl compound expressed by structural formula (24) formed the electrode layer on the aluminum foil.

Subsequently, 600 milligrams of vinylidenefluoride -hexafluoropropylene copolymer was mixed in 1400 milligrams of mixture of ethylene carbonate/propylene carbonate containing LiPF₆ at 1 mole/litter. 11.3 grams of tetrahydrofuran was added to the mixture, and the resultant mixture was mixed at room temperature. After the vinylidenefluoride-hexafluoropropylene copolymer was dissolved, the resultant solution was spread on a glass plate with a step in such a manner as to be 1 millimeter thick. The resultant glass plate was left for an hour so that the tetrahydrofuran was air-dried. Then, a layer of gel electrolyte of 150 microns thick was obtained on the glass plate.

Subsequently, a gel electrolyte layer was cut from the glass plate, and measured 2.0 centimeters by 2.0 centimeters. The piece of gel electrolyte layer was laminated on the aluminum foil formed with the electrode layer of the cyclic conjugated carbonyl compound expressed by structural formula (24). A laminated foil was prepared. The laminated foil included a lithium layer of 30 microns thick laminated with a copper foil of 20 microns thick. and a lead wire has been already connected to the laminated foil. The laminated foil was further overlaid on the gel electrolyte layer. The resultant structure was sandwiched between sheets of polytetrafluoroethylene, and pressure was applied thereto. Thus, the first sample of the battery according to the present invention was obtained.

Black slurry was produced as similar to the first sample except that the cyclic conjugated carbonyl compound expressed by structural formula (24) was not mixed. The black slurry was spread over an aluminum foil so as to form the electrode layer, and the gel electrolyte layer, which was same as that of the first sample, was laminated on the electrode layer. A laminated foil, which is also same as the laminated foil used in the first sample, was further laminated on the gel electrolyte layer. The resultant structure was sandwiched between sheets of polytetrafluoroethylene, and pressure was applied thereto. Thus, the comparative sample was obtained.

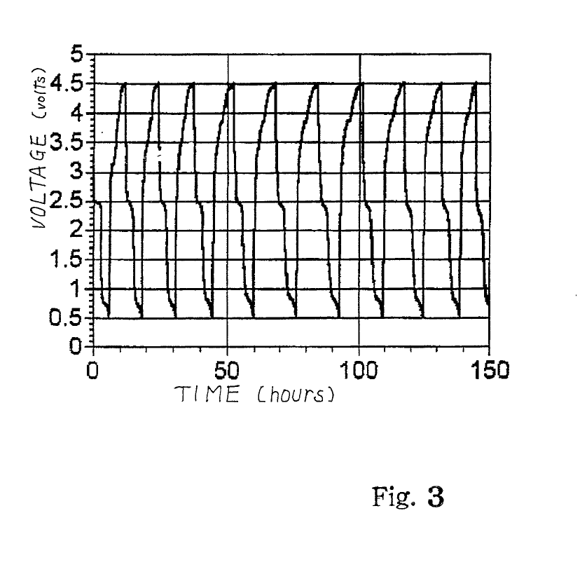

The present inventors evaluated the first sample and the comparative sample as follows. Using the lead wire connected to the aluminum foil spread with the electrode layer containing the cyclic conjugated carbonyl compound expressed by structural formula (24) and the lead wire connected to the laminated foil as the positive electrode and the negative electrode, respectively, current was constantly discharged at 0.1 milliampere. The potential level was plotted. Then, the plots had a flat portion around 2.5 volts. Thus, the present inventors confirmed that the first sample was operating as a battery. The first sample was repeatedly discharged and charged, and the potential level was varied as shown in FIG. 3. The flat portions were observed around 2.5 volts during the discharging/charging repeated ten times. Thus, the first sample was operating as a secondary battery.

The comparative sample was discharged as similar to the first sample. The potential level rapidly fell, and the comparative sample was not operating as a stable battery. The present inventors charged the comparative sample at 0.1 milliampere. The comparative sample rapidly raises the potential level over 4.5 volts. The present inventors further charged the comparative sample. However, any flat portion was not observed. The present inventors concluded that the comparative sample was not operating as a secondary battery.

Second Embodiment

The second sample was fabricated as similar to the first sample except that the cyclic conjugated carbonyl compound expressed by structural formula (24) was replaced with the cyclic conjugated carbonyl compound expressed by structural formula (22).

The second sample was evaluated as similar to the first sample. A flat portion was observed around 1.8 volts, and the present inventors confirmed that the second sample was operating as a battery.

Subsequently, the discharging/charging were repeated as similar to the first sample. Although the discharging/charging were repeated ten times, the flat portions were observed around 1.8 volts during the discharging/charging, and the present inventors confirmed that the second sample was operating as a secondary battery.

Third Embodiment to Sixth Embodiment

The third sample was fabricated as similar to the first sample except that the cyclic conjugated carbonyl compound expressed by structural formula (24) was replaced with the cyclic conjugated carbonyl compound expressed by structural formula (31). The fourth sample was fabricated as similar to the first sample except that the cyclic conjugated carbonyl compound expressed by structural formula (24) was replaced with the cyclic conjugated carbonyl compound expressed by structural formula (17). The fifth sample was fabricated as similar to the first sample except that the cyclic conjugated carbonyl compound expressed by structural formula (24) was replaced with the cyclic conjugated carbonyl compound expressed by structural formula (25). The sixth sample was fabricated as similar to the first sample except that the cyclic conjugated carbonyl compound expressed by structural formula (24) was replaced with the cyclic conjugated carbonyl compound expressed by structural formula (35).

The third to sixth samples were evaluated as similar to the first sample. A flat portion was observed in voltage characteristics of any one of the third to sixth samples, and the present inventors confirmed that the third samples to sixth sample were operating as a battery. The present inventors repeated the discharging/charging ten times, and measured the potential level. The present inventors confirmed that the third to sixth samples were operating as a secondary battery.

As will be appreciated from the foregoing description, the battery according to the present invention has at least one of the positive/negative electrodes with the active material containing the cyclic conjugated carbonyl compound with the particular structure expressed by general formula (1). The battery is high in energy density, large in capacity and stable. The cyclic conjugated carbonyl compound expressed by general formula (1) is composed of the low-mass elements. For this reason, the battery according to the present invention is superior in weight and safety to the prior art battery containing the heavy metal compound.

Although particular embodiments of the present invention have been shown and described, it will be apparent to those skilled in the art that various changes and modifications may be made without departing from the spirit and scope of the present invention.

What is claimed is:

1. A battery comprising a positive electrode, a negative electrode and electrolyte, at least one of said positive and negative electrodes including an electrode layer essentially composed of cyclic conjugated carbonyl compound having a structural unit expressed by general formula (1) 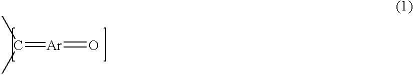
where Ar is an organic group equivalent to a compound selected from the group consisting of aromatic compound having carbon number 5 to 14 from which two hydrogen atoms are eliminated and substituted compound of said aromatic compound from which two hydrogen atoms are eliminated.

2. The battery as set forth in claim 1, in which said cyclic conjugated carbonyl compound has the structural unit expressed by general formula (2) 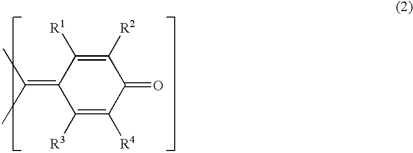
where substituents R¹ to R⁴ are independent of one another, each of the substituents R¹ to R⁴ is selected from the group consisting of hydrogen, halogen atoms, hydroxyl group, nitro group, nitroso group, cyano group, carboxyl group, alkyl group, substituted group of said alkyl group, alkenyl group, substituted group of said alkenyl group, cycloalkyl group, substituted group of said cycloalkyl group, aryl group, substituted group of said aryl group, aralkyl group, substituted group of said aralkyl group, amino group, substituted group of said amino group, alkoxy group, substituted group of said alkoxy group, aryloxy group, substituted group of said aryloxy group, alkoxycarbonyl group, substituted group of said alkoxycarbonyl group, aryloxycarbonyl group, substituted group of said aryloxycarbonyl group, acyl group and substituted group of said acyl group.

3. The battery as set forth in claim 2, in which each of said substituents R¹ to R⁴ has at least one element selected from the group consisting of sulfur atom, silicon atom, phosphorous atom and boron atom substituted for an atom thereof.

4. The battery as set forth in claim 2, in which said structural unit has two of said substituents R¹ to R⁴ adjacent to one another and forming a ring structure.

5. The battery as set forth in claim 1, in which said cyclic conjugated carbonyl compound has the structural unit expressed by general formula (3) 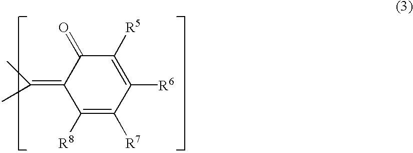
where substituents R⁵-R⁸ are independent of one another, each of the substituents R⁵ to R⁸ is selected from the group consisting of hydrogen, halogen atoms, hydroxyl group, nitro group, nitroso group, cyano group, carboxyl group, alkyl group, substituted group of said alkyl group, alkenyl group, substituted group of said alkenyl group, cycloalkyl group, substituted group of said cycloalkyl group, aryl group, substituted group of said aryl group, aralkyl group, substituted group of said aralkyl group, amino group, substituted group of said amino group, alkoxy group, substituted group of said alkoxy group, aryloxy group, substituted group of said aryloxy group, alkoxycarbonyl group, substituted group of said alkoxycarbonyl group, aryloxycarbonyl group, substituted group of said aryloxycarbonyl group, acyl group and substituted group of said acyl group.

6. The battery as set forth in claim 5, in which each of said substituents R⁵ to R⁸ has at least one element selected from the group consisting of sulfur atom, silicon atom, phosphorous atom and boron atom substituted for an atom thereof.

7. The battery as set forth in claim 5, in which said structural unit has two of said substituents R⁵ to R⁸ adjacent to one another and forming a ring structure.

8. The battery as set forth in claim 1, in which said cyclic conjugated carbonyl compound has the structural unit expressed by general formula (2) and the structural unit expressed by general formula (3) 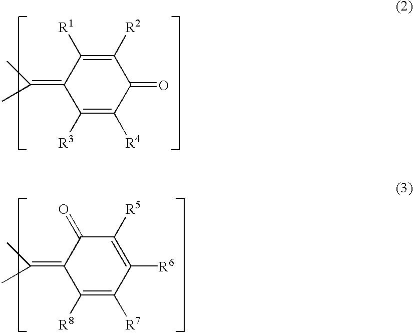
where substituents R¹ to R⁴ are independent of one another, each of the substituents R¹ to R⁴ is selected from the group consisting of hydrogen, halogen atoms, hydroxyl group, nitro group, nitroso group, cyano group, carboxyl group, alkyl group, substituted group of said alkyl group, alkenyl group, substituted group of said alkenyl group, cycloalkyl group, substituted group of said cycloalkyl group, aryl group, substituted group of said aryl group, aralkyl group, substituted group of said aralkyl group, amino group, substituted group of said amino group, alkoxy group, substituted group of said alkoxy group, aryloxy group, substituted group of said aryloxy group, alkoxycarbonyl group, substituted group of said alkoxycarbonyl group, aryloxycarbonyl group, substituted group of said aryloxycarbonyl group, acyl group and substituted group of said acyl group, substituents R⁵-R⁸ are independent of one another and substituents R⁵ to R⁸ are same as said substituents R¹ to R⁴.

9. The battery as set forth in claim 8, in which each of said substituents R¹ to R⁸ has at least one element selected from the group consisting of sulfur atom, silicon atom, phosphorous atom and boron atom substituted for an atom of thereof

10. The battery as set forth in claim 8, in which said structural unit has two of said substituents R¹ to R⁸ adjacent to one another and forming a ring structure.

11. The battery as set forth in claim 1, in which said cyclic conjugated carbonyl compound is expressed by general formula (4) 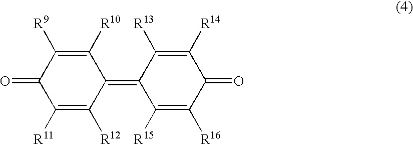
where substituents R⁹-R¹⁶ are independent of one another, each of the substituents R⁹ to R¹⁶ is selected from the group consisting of hydrogen, halogen atoms, hydroxyl group, nitro group, nitroso group, cyano group, carboxyl group, alkyl group, substituted group of said alkyl group, alkenyl group, substituted group of said alkenyl group, cycloalkyl group, substituted group of said cycloalkyl group, aryl group, substituted group of said aryl group, aralkyl group, substituted group of said aralkyl group, amino group, substituted group of said amino group, alkoxy group, substituted group of said alkoxy group, aryloxy group, substituted group of said aryloxy group, alkoxycarbonyl group, substituted group of said alkoxycarbonyl group, aryloxycarbonyl group, substituted group of said aryloxycarbonyl group, acyl group and substituted group of said acyl group.

12. The battery as set forth in claim 11, in which said compound has at least one element selected from the group consisting of sulfur atom, silicon atom, phosphorous atom and boron atom substituted for an atom of each of said substituents R⁹ to R¹⁶.

13. The battery as set forth in claim 11, in which said compound has two of said substituents R⁹ to R¹⁶ adjacent to one another and forming a ring structure.

14. The battery as set forth in claim 1, in which said cyclic conjugated carbonyl compound is expressed by general formula (5) 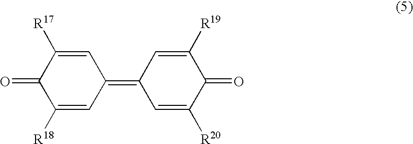
where substituents R¹⁷-R²⁰ are independent of one another, and each of the substituents R¹⁷-R²⁰ is alykyl group having carbon number 1 to 6.

15. The battery as set forth in claim 1, in which said cyclic conjugated carbonyl compound is expressed by any one of general formulae (6) to (8): 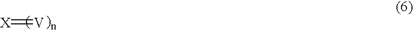
where X is an organic group equivalent to a compound selected from the group consisting of aromatic compound having carbon number 5-30 from which n hydrogen atoms are eliminated and substituted compound of said aromatic compound from which n hydrogen atoms are eliminated, V is the structural unit expressed by general formula (9), X is bonded to n structural units V independent of one another and n is an integer from 2 to 6 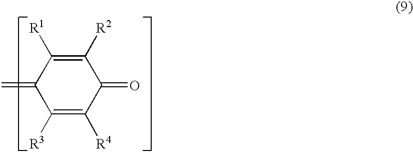
where substituents R¹ to R⁴ are independent of one another, each of the substituents R¹ to R⁴ is selected from the group consisting of hydrogen, halogen atoms, hydroxyl group, nitro group, nitroso group, cyano group, carboxyl group, alkyl group, substituted group of said alkyl group, alkenyl group, substituted group of said alkenyl group, cycloalkyl group, substituted group of said cycloalkyl group, aryl group, substituted group of said aryl group, aralkyl group, substituted group of said aralkyl group, amino group, substituted group of said amino group, alkoxy group, substituted group of said alkoxy group, aryloxy group, substituted group of said aryloxy group, alkoxycarbonyl group, substituted group of said alkoxycarbonyl group, aryloxycarbonyl group, substituted group of said aryloxycarbonyl group, acyl group and substituted group of said acyl group; 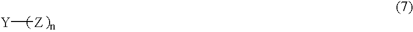
where Y is an n-valent organic group equivalent to a compound selected from the group consisting of chain hydrocarbon compound having carbon number 1 to 5 from which n hydrogen atoms are eliminated, substituted compound of said chain hydrocarbon compound from which n hydrogen atoms are eliminated, cyclic hydrocarbon compound having carbon number 3 to 30 from which n hydrogen atoms are eliminated and substituted compound of said cyclic hydrocarbon compound from which n hydrogen atoms are eliminated and bivalent sulfur atom, Z is the structural unit expressed by general formula (10), said Y is bonded to the n structural units Z independent of one another, and n is an integer from 2 to 6 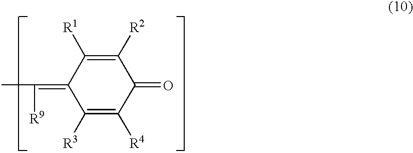
where R¹ to R⁴ are same as those in said general formula (9) and substituent R⁹ is a monovalent organic group selected from the group consisting of hydrogen, halogen atoms, hydroxyl group, nitro group, nitroso group, cyano group, carboxyl group, alkyl group, substituted group of said alkyl group, alkenyl group, substituted group of said alkenyl group, cycloalkyl group, substituted group of said cycloalkyl group, aryl group, substituted group of said aryl group, aralkyl group, substituted group of said aralkyl group, amino group, substituted group of said amino group, alkoxy group, substituted group of said alkoxy group, aryloxy group, substituted group of said aryloxy group, alkoxycarbonyl group, substituted group of said alkoxycarbonyl group, aryloxycarbonyl group, substituted group of said aryloxycarbonyl group, acyl group and substituted group of said acyl group; and 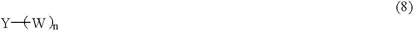
where Y is same as that in said general formula (7), W is the structural unit expressed by general formula (11), Y is bonded to the n structural units W independent of one another and n is an integer from 2 to 6 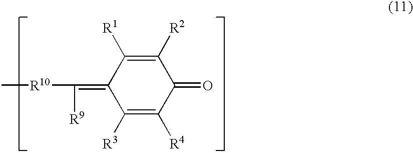
where R¹ to R⁴ and R⁹ are same as those in said general formula (10) and R¹⁰ is a bivalent organic group equivalent to a compound selected from the group consisting of aliphatic hydrocarbon compound from which two hydrogen atoms are eliminated, substituted compound of said aliphatic hydrocarbon compound from which two hydrogen atoms are eliminated, aromatic hydrocarbon compound from which two hydrogen atoms are eliminated, substituted compound of said aromatic hydrocarbon compound from which two hydrogen atoms are eliminated, amine compound from which two hydrogen atoms are eliminated, substituted compound of said amine compound from which two hydrogen atoms are eliminated, ether compound from which two hydrogen atoms are eliminated, substituted compound of said ether compound from which two hydrogen atoms are eliminated, ester compound from which two hydrogen atoms are eliminated, substituted compound of said ester compounds from which two hydrogen atoms are eliminated, ketone compound from which two hydrogen atoms are eliminated, substituted compound of said ketone compound from which two hydrogen atoms are eliminated, amido compound from which two hydrogen atoms are eliminated, substituted compound of said amido from which two hydrogen atoms are eliminated, certain compound having any one of the combinations of the functional groups contained in the substituted/non-substituted aliphatic hydrocarbon compounds, the substituted/non-substituted aromatic hydrocarbon compounds, said substituted/non-substituted amine compound, said substituted/non-substituted ether compound, said substituted/non-substituted ester compound, said substituted/non-substituted ketone compound and said substituted/non-substituted amido compound and from which two hydrogen atoms are eliminated.

16. The battery as set forth in claim 15, in which said n-valent organic group has at least one element selected from the group consisting of oxygen atom, nitrogen atom, sulfur atom, silicon atom, phosphorous atom and boron atom and substituted for at least one carbon atom thereof.

17. The battery as set forth in claim 15, in which said bivalent organic group has at least one element selected from the group consisting of oxygen atom, nitrogen atom, sulfur atom, silicon atom, phosphorous atom or boron atom and substituted for at least one atom thereof.

18. The battery as set forth in claim 1, in which said cyclic conjugated carbonyl compound is polymer compound containing the structural unit expressed by general formula (12) 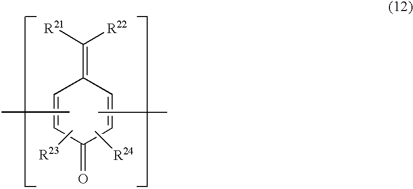
where substituents R²¹ to R²⁴ are independent of one another, each of the substituents R²¹ to R²⁴ is selected from the group consisting of hydrogen, halogen atoms, hydroxyl group, nitro group, nitroso group, cyano group, carboxyl group, alkyl group, substituted group of said alkyl group, alkenyl group, substituted group of said alkenyl group, cycloalkyl group, substituted group of said cycloalkyl group, aryl group, substituted group of said aryl group, aralkyl group, substituted group of said aralkyl group, amino group, substituted group of said amino group, alkoxy group, substituted group of said alkoxy group, aryloxy group, substituted group of said aryloxy group, alkoxycarbonyl group, substituted group of said alkoxycarbonyl group, aryloxycarbonyl group, substituted group of said aryloxycarbonyl group, acyl group and substituted group of said acyl group.

19. The battery as set forth in claim 18, in which each of said substituents R²¹ to R²⁴ has at least one element selected from the group consisting of sulfur atom, silicon atom, phosphorous atom and boron atom substituted for an atom thereof.

20. The battery as set forth in claim 18, in which said structural unit has two of said substituents R²¹ to R²⁴ adjacent to one another and forming a ring structure.

21. The battery as set forth in claim 1, in which said cyclic conjugated carbonyl compound is polymer compound containing the structural unit expressed by general formula (13) 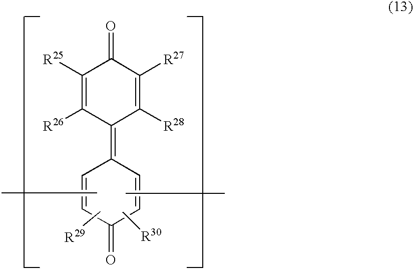
where substituents R²⁵ to R ³⁰ are independent of one another, each of the substituents R²⁵ to R³⁰ is selected from the group consisting of hydrogen, halogen atoms, hydroxyl group, nitro group, nitroso group, cyano group, carboxyl group, alkyl group, substituted group of said alkyl group, alkenyl group, substituted group of said alkenyl group, cycloalkyl group, substituted group of said cycloalkyl group, aryl group, substituted group of said aryl group, aralkyl group, substituted group of said aralkyl group, amino group, substituted group of said amino group, alkoxy group, substituted group of said alkoxy group, aryloxy group, substituted group of said aryloxy group, alkoxycarbonyl group, substituted group of said alkoxycarbonyl group, aryloxycarbonyl group, substituted group of said aryloxycarbonyl group, acyl group and substituted group of said acyl group.

22. The battery as set forth in claim 21, in which each of said substituents R²⁵ to R³⁰ has at least one element selected from the group consisting of sulfur atom, silicon atom, phosphorous atom and boron atom substituted for an atom thereof.

23. The battery as set forth in claim 21, in which said structural unit has two of said substituents R²⁵ to R³⁰ adjacent to one another and forming a ring structure.

24. The battery as set forth in claim 1, in which said cyclic conjugated carbonyl compound is polymer compound containing the structural unit expressed by general formula (14) 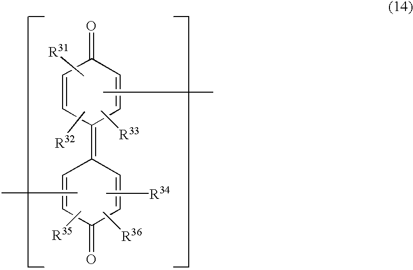
where substituents R³¹ to R³⁶ are independent of one another, each of the substituents R³¹ to R³⁶ is selected from the group consisting of hydrogen, halogen atoms, hydroxyl group, nitro group, nitroso group, cyano group, carboxyl group, alkyl group, substituted group of said alkyl group, alkenyl group, substituted group of said alkenyl group, cycloalkyl group, substituted group of said cycloalkyl group, aryl group, substituted group of said aryl group, aralkyl group, substituted group of said aralkyl group, amino group, substituted group of said amino group, alkoxy group, substituted group of said alkoxy group, aryloxy group, substituted group of said aryloxy group, alkoxycarbonyl group, substituted group of said alkoxycarbonyl group, aryloxycarbonyl group, substituted group of said aryloxycarbonyl group, acyl group and substituted group of said acyl group.

25. The battery as set forth in claim 24, in which each of said substituents R³¹ to R³⁶ has at least one element selected from the group consisting of sulfur atom, silicon atom, phosphorous atom and boron atom substituted for an atom thereof.

26. The battery as set forth in claim 24, in which said structural unit has two of said substituents R³¹ to R³⁶ adjacent to one another and forming a ring structure.

27. The battery as set forth in claim 1, in which said cyclic conjugated carbonyl compound is polymer containing the structural unit expressed by general formula (15) 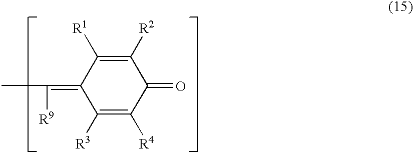
where R¹ to R⁴ and R⁹ are same as those in said general formula (10).

28. The battery as set forth in claim 27, in which each of said substituents R¹ to R⁴ and R⁹ has at least one element selected from the group consisting of sulfur atom, silicon atom, phosphorous atom and boron atom substituted for an atom thereof.

29. The battery as set forth in claim 27, in which said structural unit has two of said substituents R¹ to R⁴ and R⁹ adjacent to one another and forming a ring structure.

30. The battery as set forth in claim 1, in which said cyclic conjugated carbonyl compound is polymer containing the structural unit expressed by general formula (16) 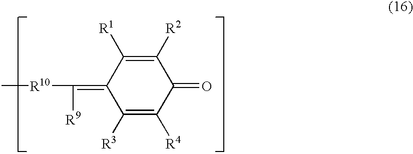
where R¹ to R⁴, R⁹ and R¹⁰ are same as those in said general formula (11).

31. The battery as set forth in claim 30, in which each of said substituents R¹ to R⁴, R⁹ and R¹⁰ has at least one element selected from the group consisting of sulfur atom, silicon atom, phosphorous atom and boron atom substituted for an atom thereof.

32. The battery as set forth in claim 30, in which said structural unit has two of said substituents R¹ to R⁴, R⁹ and R¹⁰ adjacent to one another and forming a ring structure.

33. The battery as set forth in claim 1, in which said positive electrode contains said cyclic conjugated carbonyl compound.

34. The battery as set forth in claim 1, said battery serving as a lithium secondary battery.
